(19) United States
(12) Patent Application Publication
(10) Pub. No.: US 2020/0221055 A1
(43) Pub. Date: Jul. 9, 2020

(54) SYSTEMS AND METHODS FOR COMPRESSION AND RECOVERY OF DATA IN ADDITIVE MANUFACTURING APPLICATIONS

(71) Applicant: UNITED TECHNOLOGIES CORPORATION, Farmingham, CT (US)

(72) Inventors: AMIT SURANA, Newington, CT (US); REBECCA L. RUNKLE, Manchester, CT (US)

(73) Assignee: UNITED TECHNOLOGIES CORPORATION, Farmington, CT (US)

(21) Appl. No.: 16/239,245

(22) Filed: Jan. 3, 2019

(51) Int. Cl. H04N 7/18; G05B 19/414; H04N 1/21; B33Y 50/00

(52) U.S. Cl. CPC H04N 7/183; G05B 19/4142; H04N 1/2133; B22F 3/1055; G05B 2219/49007; G05B 2219/34215; H04N 2201/0084; B33Y 50/00

(57) ABSTRACT

A method for monitoring an additive manufacturing process during fabrication of a component part is disclosed. In various embodiments, the method includes the steps of selecting a sensing matrix; orienting a sensor toward a surface of the component part; generating a discrete time signal, based on data obtained from the sensor, the discrete time signal being representative of a process condition of the component part while the component part is undergoing the additive manufacturing process; compressing the discrete time signal using the sensing matrix to form a compressed measurement signal; and storing the compressed measurement signal in a storage device while the component part is undergoing the additive manufacturing process. In various embodiments, selecting the sensing matrix comprises selecting a basis function. In various embodiments, the basis function is determined using a random time sampling.

### FIELD

The present disclosure relates generally to additive manufacturing and, more particularly, to systems and methods used to compress and recover monitoring data generated during additive manufacturing applications.

### BACKGROUND

Additive manufacturing (AM) is a method of manufacture where component parts are constructed through layer-by-layer deposition of material. Compared to other methods of manufacture, AM offers several advantages, including, for example, reduced material waste, part consolidation and the ability to produce parts directly without the need for expensive part-specific tooling. Metallic AM methods, including, for example, laser powder bed fusion (L-PBF), are capable of producing net-shape parts by utilizing thin (e.g., 20-80 μm) layers of material and small (e.g., 50-100 μm) laser spot sizes. Unlike the case with more conventional methods, such as forging or casting, metallic AM methods may be used to create parts having complex internal geometries.

Despite AM methods having advantages over more conventional manufacturing methods, achieving high levels of quality and repeatability for metallic parts remains a challenging task due to several factors, including, for example, the high complexity of the underlying physical phenomena and material transformations that take place during the manufacturing process and the lack of formal mathematical and statistical models needed to control the build process and ensure part quality. The ability to efficiently and economically produce parts that are consistent across machines, operators and manufacturing facilities is desirable such that AM methods may provide a more efficient and economical method of manufacture for parts having complex internal geometries. To this end, increasing emphasis is being directed to in situ process monitoring and control through use of sensors and imaging devices.

Configurations for incorporating sensors and imagers into an AM system include staring configurations, where a sensor or imager has a stationary view of an entire portion of a build plane, and co-axial imaging configurations, where an imager or sensor is optically aligned with a laser beam such that the field of view is confined to and moves with the laser spot or a melt pool created by the laser spot. For example, optimal tomography systems and powder bed optical cameras may be deployed in staring configurations and provide layer-wise images of a build area after each layer is applied. Photodiodes, on other hand, may be configured into either staring or co-axial imaging configurations and provide a voltage versus time series of data proportional to the thermal radiation being emitted during the build process for a given field of view.

Characteristic dimensions for an AM process may be on the order of hundreds of millimeters for the build plane or hundreds of micrometers for the melt pool. Moreover, laser spot speeds across the build plane may approach thousands of millimeters per sec. For these reasons, detectors and imagers used in staring and co-axial configurations can require hundreds or even thousands of mega pixels to resolve an area of interest (e.g., an entire build plane) or utilize high data acquisition rates during the storage process of following transient processes (e.g., while tracking the melt pool across a build plane). Thus, systems and methods for compressing sensor or imaging data, as the data is being generated, may contribute to the design of more efficient and economical AM methods and apparatus.

### SUMMARY

A method for monitoring an additive manufacturing process during fabrication of a component part is disclosed. In various embodiments, the method includes the steps of selecting a sensing matrix; orienting a sensor toward a surface of the component part; generating a discrete time signal, based on data obtained from the sensor, the discrete time signal being representative of a process condition of the component part while the component part is undergoing the additive manufacturing process; compressing the discrete time signal using the sensing matrix to form a compressed measurement signal; and storing the compressed measurement signal in a storage device while the component part is undergoing the additive manufacturing process. In various embodiments, selecting the sensing matrix comprises selecting a basis function. In various embodiments, the basis function is determined using a random time sampling. In various embodiments, a basis matrix is also selected and used for signal reconstruction. The sensing matrix is selected so that it is incoherent w.r.t to basis in which the sensor signal is sparse.

In various embodiments, the sensor comprises a staring imager configured to image a build plane of the component part while the component part is undergoing the additive manufacturing process. In various embodiments, the sensor comprises a co-axial imager configured to image a melt pool of the component part while the component part is undergoing the additive manufacturing process.

In various embodiments, the method further includes recovering the compressed measurement signal from the storage device and decompressing the compressed measurement signal to obtain a reconstructed signal. In various embodiments, the reconstructed signal approximates the discrete time signal. In various embodiments, the method further includes selecting a basis matrix and decompressing the compressed measurement signal using a solution to an optimization problem and a matrix multiplication between a solution vector and the basis matrix. In various embodiments, selecting the basis matrix comprises selecting a basis function. In various embodiments, the basis function is determined from a set of Fourier bases, wavelet packet decompositions, dynamic mode decompositions, or overcomplete dictionaries. In various embodiments, the method further includes determining if the reconstructed signal indicates a defect in the component part.

An additive manufacturing system for fabricating a component part is disclosed. In various embodiments, the system includes a storage device; a sensor configured for orientation toward a surface of the component part; and a processor in communication with the storage device, the processor configured to perform: selecting a sensing matrix, orienting the sensor toward the surface of the component part, generating a discrete time signal, based on data obtained from the sensor, the discrete time signal being representative of a process condition of the component part while the component part is undergoing fabrication, compressing the discrete time signal using the sensing matrix to form a compressed measurement signal, and storing the compressed measurement signal in the storage device while the component part is undergoing fabrication.

In various embodiments, the sensor is configured to image at least one of a build plane and a melt pool of the component part while the component part is undergoing fabrication. In various embodiments, the processor is configured to recover the compressed measurement signal from the storage device and decompress the compressed measurement signal to obtain a reconstructed signal. In various embodiments, the reconstructed signal approximates the discrete time signal. In various embodiments, decompressing the compressed measurement signal comprises solving an optimization problem and a matrix multiplication between a solution vector and a basis matrix. In various embodiments, the basis matrix comprises a set of basis functions configured to sparsely represent the discrete time signal. In various embodiments, the basis function is selected from a set of Fourier bases, wavelet packet decompositions, dynamic mode decompositions or overcomplete dictionaries. In various embodiments, the sensor is at least one of a staring imager and a co-axial imager.

An apparatus for monitoring additive manufacturing of a component part is disclosed. In various embodiments, the apparatus includes a processor in communication with a storage device, the processor configured to orient a sensor toward at least one of a build plane and a melt pool of the component part while the component part is undergoing the additive manufacturing, generate a discrete time signal, based on data obtained from the sensor, the discrete time signal being representative of a process condition of the component part while the component part is undergoing the additive manufacturing, compress the discrete time signal using a sensing matrix to form a compressed measurement signal, and store the compressed measurement signal in the storage device while the component part is undergoing the additive manufacturing.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a schematic view of an additive manufacturing system, in accordance with various embodiments;

FIG. 2 is a schematic view of an additive manufacturing system, in accordance with various embodiments;

FIG. 3 describes a method for in situ monitoring of an additive manufacturing process, in accordance with various embodiments; and

FIG. 4 illustrates a graph showing reconstruction accuracy of a discrete time signal, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

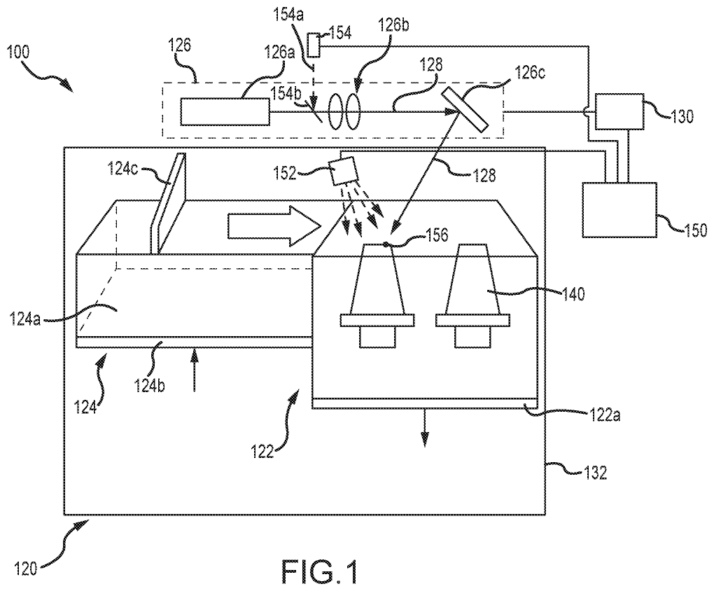

Referring now to the drawings, FIG. 1 illustrates an additive manufacturing system 100, in accordance with various embodiments. The additive manufacturing system 100 may comprise a powder bed fusion machine 120 configured to fabricate a component part 140 using an additive manufacturing process. Although the component part 104 illustrated in FIG. 1 takes the form of an airfoil (e.g., a turbine blade), the disclosure contemplates myriad other such component parts, including, without limitation, seals, tubes, brackets, fuel nozzles, heat shields, liners or panels. Additionally, the component parts may be fabricated from a wide range of materials, including, but not limited to, metal alloys. Further, while the disclosure focuses on the powder bed fusion machine 120 described herein, the disclosure also contemplates other additive manufacturing equipment and processes and, therefore, is not intended to be limited to the powder bed fusion equipment and processes described herein.

In various embodiments, the powder bed fusion machine 120 generally includes a work bed 122, a powder deposition device 124 that is operable to deposit a powder (e.g., a metal powder) in the work bed 122, an energy beam device 126 configured to emit an energy beam 128 onto the work bed 122 and toward the component part 140 during fabrication of the part. In various embodiments, the energy beam 128 exhibits a variable power and a variable scan rate configured to melt and fuse regions of the powder. The additive manufacturing system 100 may further comprise a controller 130 in communication with the energy beam device 126 and, as described below, other components of the system, including, for example, a monitoring system 150. An environmental chamber 132 may be used to enclose one or more components of the additive manufacturing system 100, including, for example, the work bed 122 and the powder deposition device 124. Additional components, such as, but not limited to, vacuum pumps, process gas sources and related valves may be included in the additive manufacturing system 100.

With continued reference to FIG. 1, in various embodiments, the work bed 122 includes a build plate 122a upon which the powder is deposited and the component part 140 is built. The build plate 122a may be actuated using a piston or the like to lower the build plate 122a during the process. The powder deposition device 124 may include a powder supply bed 124a supported on a bed plate 124b, and a re-coater arm 124c. The bed plate 124b may be actuated using a piston or the like to raise the bed plate 124b during the fabrication process. The re-coater arm 124c is operable to move across the powder supply bed 124a and the work bed 122, to deposit layers of powder in the work bed 122. Operation of the work bed 122 and powder deposition device 124 may be controlled via the controller 130. In various embodiments, the energy beam device 126 includes a laser 126a, one or more lenses 126b and a mirror 126c. The mirror 126c may be actuated (at the command of the controller 130) to control the direction of the energy beam 128 onto the work bed 122 and the component part 140. The laser 126a and the one or more lenses 126b may be modulated (at the command of the controller 130) to control the power of the energy beam 128. For example, the energy beam 128 can be operated with varied energy levels as required to maintain processing parameters and to mitigate defect formation. Although the additive manufacturing system 100 is illustrated as including the laser 126a, the disclosure is not so limited and contemplates the energy beam device 126 comprising other sources of energy, such as, for example, an electron beam gun, multiple electron beam guns or multiple lasers, and the laser or lasers may be continuous or intermittent (e.g., pulsing).

Still referring to FIG. 1, in various embodiments, the monitoring system 150 includes one or more sensors or imagers configured to monitor the fabrication of the component part 140. For example, and without limitation, the monitoring system 150 may include one or both of a staring imager 152 and a co-axial imager 154. In various embodiments, the staring imager 152 comprises an imager or detector having a stationary view of a build plane, either in its entirety or a portion thereof. For example, the staring imager 152 may comprise one or more of an optimal tomography system, a powder bed imaging system, a thermal camera, an acoustic sensor, a laser profiler, an X-ray imager, an eddy current sensor, a spectrometer, an ultra sound sensor or a photodiode, each of which may be deployed in a stationary configuration to provide layer-wise images of the build plane after each layer is built during the fabrication process. In various embodiments, the co-axial imager 154 comprises an imager or detector having a non-stationary view, where the imager or detector is optically aligned with the energy beam 128 such that a field of view 154a is directed through a beam splitter 154b and co-aligned with a laser spot 156 where the energy beam 128 intersects with the build plane during fabrication of the component part 140. In various embodiments, the co-axial imager 154 comprises a photodiode configured to image the melt pool as the pool moves along the build plane with the laser spot 156. Other imagers or detectors may be used with the monitoring system 150, including, for example, single-pixel imagers, multi-pixel imagers, high speed visible light cameras, thermal/IR cameras, powder bed optical cameras, laser profilers or any other melt pool monitoring systems. The disclosure contemplates any number of imagers, sensors or detectors for use with the monitoring system 150, including, for example, multiple staring imagers and multiple co-axial imagers.

The controller 130 may include hardware (e.g., one or more microprocessors, memory, etc.), software or combinations thereof that are programmed to perform any or all the functions described herein. The controller 130 is operable to dynamically control at least one of the beam power or the beam scan rate to control how and where the powder melts and fuses in the work bed 122. The control of power and scan rates may also extend to “resting time” of the energy beam device 126, during which time the power and the scan rate are set equal to zero. For instance, the “resting time” parameter may be used when the powder bed is being re-coated, and time can be added to start the process (which may also depend on the number of parts being built in the work bed 122 because the energy beam 128 “jumps” from one part to another). The term “dynamically control” refers to the ability of the controller 130 to change at least one of the power and the scan rate as the energy beam 128 scans across the build plane to melt and fuse the powder during an additive manufacturing process. The controller 130 is also operable to control the monitoring system 150. For example, the controller 130 is configured to select sampling rates for the staring imager 152 and the co-axial imager 154 and to control movement of the co-axial imager 154 such that the imager is maintained on the time-dependent location of the laser spot 156.

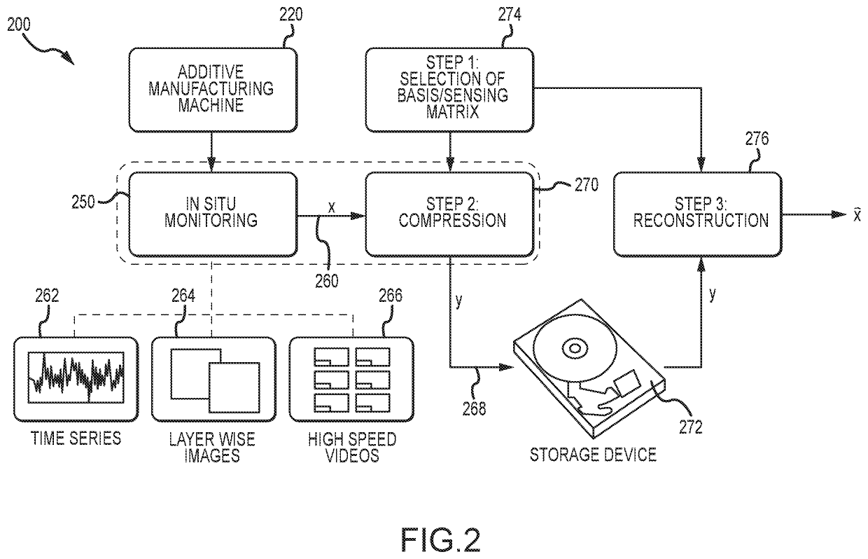

Referring now to FIG. 2, an additive manufacturing system 200, configured for in situ monitoring of an additive manufacturing process, is illustrated in the form of a block diagram. In various embodiments, the additive manufacturing system 200 is similar to the additive manufacturing system 100, described above with reference to FIG. 1. The additive manufacturing system 200 includes an additive manufacturing machine 220, such as, for example, the powder bed fusion machine 120 described above with reference to FIG. 1. In addition, the additive manufacturing system 200 includes a monitoring system 250, similar to the monitoring system 150 described above with reference to FIG. 1, that is configured for in situ monitoring of the additive manufacturing process.

In various embodiments, the monitoring system 250 includes one or more sensors or detectors, such as, for example, the staring imager 152 and the co-axial imager 154 described above with reference to FIG. 1. For example, in various embodiments, the one or more sensors or detectors is configured to provide sensor data 260 in the form of one or more of a time series 262, a layer-wise image 264 and a high-speed video 266. In various embodiments, the sensor data 260 may be represented by a finite-length, one-dimensional discrete time signal x ∈ Rⁿ, which may be viewed as a nx1 real valued column vector with components x[t], t=1 . . . , n. The sensor data 260 may be used advantageously to monitor the progress of the fabrication of a component part, such as, for example, the component part 140 described above with reference to FIG. 1, and to detect defects that might occur during the fabrication process. In various embodiments, the sensor data 260 may be representative of or provide a process condition during the fabrication of the component part. For example, in various embodiments, a process condition may include physical characteristics or indicators of the presence of defects of the part at the build plane or the melt pool at the time of sensing of the component part undergoing an additive manufacturing process. Beneficially, the sensor data 260 may also be used to accelerate process parameter development for new materials, reduce the time or cost associated with ex situ or post build characterization, detect build failures at the time of fabrication so an additive manufacturing process may be terminated prior to completion to conserve what would become otherwise wasted material and machine time, and enable feedback control to facilitate online adaptation of build process parameters in order to improve build quality.

Defects occurring during an additive manufacturing process include, for example, key-holing, balling and unmelt porosity and their detection may be undertaken by analysis of the sensor data 260 following or during fabrication of the component part. As described above, however, the sheer size of the sensor data 260 and, in particular, the discrete time signal x, may render storage of the sensor data 260, in its entirety, prohibitive, as well as any post-fabrication analysis of the sensor data 260. To address the storage problem, a compression module 270 is included within the additive manufacturing system 200. In various embodiments, the compression module 270 receives the sensor data 260, i.e., the discrete time signal x, operates on the sensor data 260, as described below, and then outputs a compressed measurement data 268 in the form of a compressed measurement signal y ∈ R^{m}, which may be viewed as a mx1 real valued column vector representation of the sensor data 260 where, typically, m <<n. The compressed measurement signal y may then be stored in a storage device 272 during the fabrication of the component part and saved for analysis following completion of the fabrication process. This latter feature obviates the need to acquire and temporarily store the full sensor data, prior to subsequent compression following completion of the fabrication process. In addition, the compression module 270 may serve to improve spatial resolution of data acquired via co-axial imagers that may be otherwise limited in the ability to store and process data because of limitations on data transfer rates.

Still referring to FIG. 2, in various embodiments, the steps involved in compressing the sensor data 260 into the compressed measurement data 268 may be described with reference to a selection module 274 and the compression module 270. Subsequent reconstruction of the sensor data 260 from the compressed measurement data 268 may be described with further reference to a reconstruction module 276. As described below, the various steps follow a compressive sensing procedure. For example, in a first step, performed by the selection module 274, a basis matrix Ψ={ψᵢ, i=1 . . . , n} is selected such that the discrete time signal x can be represented as a linear combination of the columns of the basis matrix Ψ, or the basis vectors ψᵢ, as x=Σᵢ₌₁ⁿSᵢψᵢ=Ψ_{S}, where s ∈ Rⁿ is a sparse coefficient vector of length n having n-k values that are small or equal to zero. Also performed by the selection module 274 is the selection of a set of sensing waveforms _{φi} ∈ Rⁿ, such that a sensing matrix Φ={φₖ,=1, . . . , m} may be defined, where Φ ∈ R^{mxn} and incoherent with respect to the basis matrix ψ. Here, incoherence implies that, unlike the signal of interest—e.g., the sensor data 260 —the sensing waveforms _{φk} have a dense representation. In various embodiments, the selection module 274 is configured to select the basis matrix Ψ and the sensing matrix Φ only once, using, for example, delta spikes (e.g., _{φk}(t)=δ (t-k)) for the sensing matrix Φ and Fourier bases (e.g., _{104 i}(t)=n^{-1/2}e^{i2πjt/n}) for the basis matrix Ψ. In various embodiments, one or more of wavelet decompositions, dynamic mode decompositions, or overcomplete dictionaries may also be used to construct the sensing or basis matrices.

Following selection of the sensing matrix Φ and the basis matrix Ψ by the selection module 274, compression of the sensor data 260 may take place in the compression module 270. In this step, the sensor data 260 (e.g., data appearing as one or more of the time series 262, the layer-wise image 264 and the high-speed video 266) is provided to the compression module 270 in the form of the discrete time signal x. The discrete time signal x, which may be vectorized as described above, is compressed into a measurement vector y ∈ R^{m} using the sensing matrix Φ, such that y=Φx. Since m<<n, the measurement vector y has a significantly smaller number of components or entries than the discrete time signal x. The measurement vector y may then be efficiently transmitted and stored into an appropriate storage device, such as, for example, the storage device 272 described above and illustrated in FIG. 2. Transmitting and storing the measurement vector y, which may require substantially less bandwidth or data rate than the discrete time signal x, may then be made available for analysis, either on the fly or following fabrication of the component part.

In a third step, the discrete time signal x may be recovered exactly or approximately from the measurement vector y, which resides in the storage device 272. In various embodiments, for example, the measurement vector y is retrieved from the storage device 272 and a numerical optimization procedure is used to reconstruct the discrete time signal x. In various embodiments, the numerical optimization comprises solving for

$${s}^{*} = {min}_{{s}_{i} , i = 1 , … , m} {\sum }_{i = 1}^{m} \vert {s}_{i} \vert ,$$

subject to the constraint ΦΨs=y. The discrete time signal x, may then be recovered (or closely approximated) through the relation x=Ψs*, where s* is a solution vector of the foregoing minimization subject to the constraint.

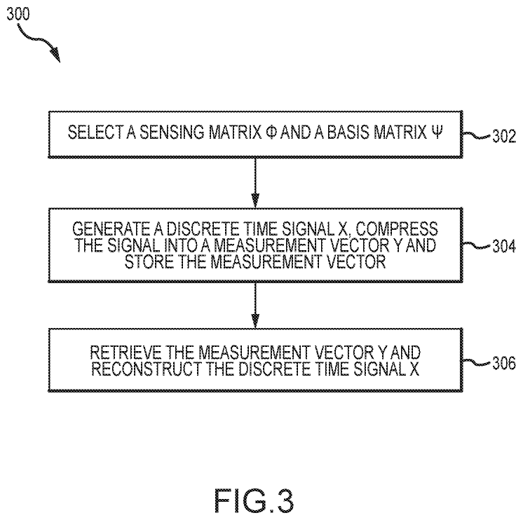

Referring now to FIG. 3, the foregoing may be summarized as a method 300 for in situ monitoring of an additive manufacturing process. In various embodiments, the method 300 comprises three principal steps. In a first step 302, a sensing matrix Φ and a basis matrix Ψ are selected and constructed based on a further selection of a basis function for each of the matrices. In various embodiments, the sensing matrix and the basis matrix are selected to be incoherent. In a second step 304, a discrete time signal x, representing details of the additive manufacturing process (e.g., stationary or time dependent imaging of a build plane or a melt pool during the fabrication of a component part) is compressed into a measurement vector y by multiplying the sensing matrix Φ selected in the first step 302 with the discrete time signal x. The measurement vector y is then stored on a storage device. In a third step 306, the measurement vector is retrieved from the storage device and used to recreate the discrete time signal x.

In various embodiments, implementation of the second step 304 assumes the data comprising the discrete time signal x is first collected by a sensor and then compressed to obtain the measurement vector y, which is smaller in size than the discrete time signal x. Because the compression involves multiplication of a matrix by a vector, the multiplication may be efficiently implemented in situ using embedded software or directly on hardware chips. In addition, during the data collection phase, imaging rates may be selected to further reduce the size of the measurement vector y. In various embodiments, for example, let sₘᵢₙδ t be the minimum allowed separation between samples, and sₘₐₓδ t be the maximum allowed separation between the samples, where δ t is the sampling time and sₘᵢₙ and sₘₐₓ are integers. Then compressed sampling can be accomplished by randomly selecting an integer j₁, j₂, . . . uniformly distributed between sₘᵢₙ and sₘₐₓ, and only sampling the signal in between time intervals j₁δ t, j₂δ t, . . . , rather than uniformly sampling, for example, at 0; δ t, 2δ t, . . . . This strategy may be referred to as random time sampling and is equivalent to having a sensing matrix with rows as a randomly selected subset from the standard basis vectors. In various embodiments, this strategy of in situ compression facilitates transmission of sensor data (e.g. video) at high spatial resolution (by lowering the sampling rate). Furthermore, since only reduced measurements are obtained, the strategy leads to a more efficient storage of the resulting measurement vector.

In a second approach, the steps of collecting and compressing signal data may be combined into a single step using a single pixel camera (represented by the dashed box 280 in FIG. 2) A single pixel camera includes an architecture that employs a digital micromirror array to perform optical calculations of linear projections of an image onto pseudorandom binary patterns. The calculations may be represented by the matrix operation y=Φx described above. Combining this second step 304 with the third step 306 (reconstruction), a single pixel camera may be used to obtain an image with a single detection element while sampling the image fewer times than the number of pixels typically used in an ordinary camera.

While the above is described in terms of compressing a single discrete time signal x taken from a single imager (or sensor or detector), the disclosure contemplates alternative compression approaches, such as, for example, compressing multiple discrete time signals (or data streams) taken from multiple imagers (or sensors or detectors) simultaneously. In various embodiments, for example, the multiple discrete time signals may be combined in some temporal fashion as received at the compression module (e.g., by compressing a fixed length of data from each sensor as such is received). In various embodiments, a correlation between the multiple sensors may also be exploited to accomplish the combining of sensor data. In addition, various embodiments of the disclosure contemplate multiple compression modules or selection modules to compress the discrete time signals (or data streams) received from multiple imagers.

### Example 1

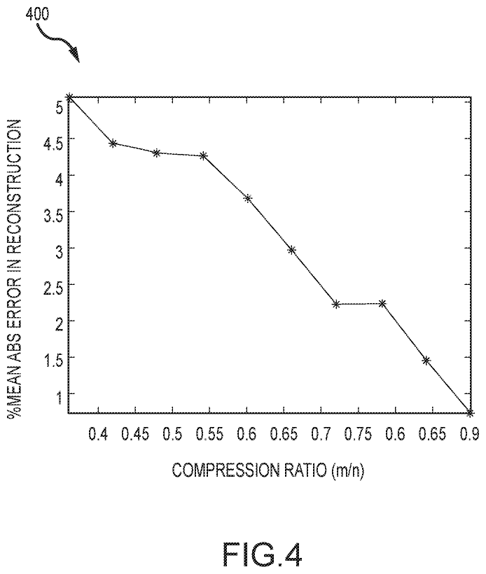

The foregoing description has been applied to monitor an additive manufacturing process. A discrete time signal x in the form of a time series is obtained using a photodiode during an additive manufacturing process using a laser power bed fusion machine. The basis matrix Ψ used in compressing the discrete time signal x is constructed using Fourier basis functions and the sensing matrix Φ is constructed using a random time sampling strategy similar to that described above. A graph 400 showing reconstruction accuracy of the discrete time signal x is provided in FIG. 4. The reconstruction accuracy is defined as the mean absolute relative error in reconstructing each frequency component of the discrete time signal x as a function of the compression ration m/n. For this example, the error approaches zero as the compression ratio approaches unity. At compression ratios on the order of m/n=0.35, the method used in this example results in a mean error on the order of five percent (5%).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, system program instructions or controller instructions may be loaded onto a tangible, non-transitory, computer-readable medium (also referred to herein as a tangible, non-transitory, memory) having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media that were found by In Re Nuijten to fall outside the scope of patentable subject matter under 35 U.S.C. § 101.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. A method for monitoring an additive manufacturing process during fabrication of a component part, comprising:
selecting a sensing matrix, the sensing matrix comprising a set of sensing waveforms, _{101 i} ∈ R^{n.}, orienting a sensor toward a surface of the component part;
generating a discrete time signal, x ∈ Rⁿ, based on data obtained from the sensor, the discrete time signal being representative of a process condition of the component part while the component part is undergoing the additive manufacturing process;
compressing the discrete time signal using the sensing matrix to form a compressed measurement signal; and
storing the compressed measurement signal in a storage device while the component part is undergoing the additive manufacturing process.

2. The method of claim 1, wherein selecting the sensing matrix comprises selecting a basis function.

3. The method of claim 2, wherein the basis function is determined using a random time sampling.

4. The method of claim 1, wherein the sensor comprises a staring imager configured to image a build plane of the component part while the component part is undergoing the additive manufacturing process.

5. The method of claim 1, wherein the sensor comprises a co-axial imager configured to image a melt pool of the component part while the component part is undergoing the additive manufacturing process.

6. The method of claim 1, further comprising recovering the compressed measurement signal from the storage device and decompressing the compressed measurement signal to obtain a reconstructed signal.

7. The method of claim 6, wherein the reconstructed signal approximates the discrete time signal.

8. The method of claim 7, further comprising selecting a basis matrix and wherein decompressing the compressed measurement signal comprises solving an optimization problem and a matrix multiplication between a solution vector and the basis matrix.

9. The method of claim 8, wherein selecting the basis matrix comprises selecting a basis function.

10. The method of claim 9, wherein the basis function is determined from a set of Fourier bases, wavelet packet decompositions, dynamic mode decompositions or overcomplete dictionaries.

11. The method of claim 7, further comprising determining if the reconstructed signal indicates a defect in the component part.

12. An additive manufacturing system for fabricating a component part, comprising:
a storage device;
a sensor configured for orientation toward a surface of the component part; and
a processor in communication with the storage device, the processor configured to perform:
selecting a sensing matrix, the sensing matrix comprising a set of sensing waveforms, _{Φi} ∈ Rⁿ,
orienting the sensor toward the surface of the component part,
generating a discrete time signal, x ∈ Rⁿ, based on data obtained from the sensor, the discrete time signal being representative of a process condition of the component part while the component part is undergoing fabrication,
compressing the discrete time signal using the sensing matrix to form a compressed measurement signal, and
storing the compressed measurement signal in the storage device while the component part is undergoing fabrication.

13. The system of claim 12, wherein the sensor is configured to image at least one of a build plane and a melt pool of the component part while the component part is undergoing fabrication.

14. The system of claim 13, wherein the processor is configured to recover the compressed measurement signal from the storage device and decompress the compressed measurement signal to obtain a reconstructed signal.

15. The system of claim 14, wherein the reconstructed signal approximates the discrete time signal.

16. The system of claim 15, wherein decompressing the compressed measurement signal comprises solving an optimization problem and a matrix multiplication between a solution vector and a basis matrix.

17. The system of claim 16, wherein the basis matrix comprises a basis function.

18. The system of claim 17, wherein the basis function is selected from a set of Fourier bases, wavelet packet decompositions, dynamic mode decompositions or overcomplete dictionaries.

19. The system of claim 13, wherein the sensor is at least one of a staring imager and a co-axial imager.

20. An apparatus for monitoring additive manufacturing of a
a processor in communication with a storage device, the processor configured to
orient a sensor toward at least one of a build plane and a melt pool of the component part while the component part is undergoing the additive manufacturing,
generate a discrete time signal, x ∈ Rⁿ, based on data obtained from the sensor, the discrete time signal being representative of a process condition of the component part while the component part is undergoing the additive manufacturing,
compress the discrete time signal using a sensing matrix, the sensing matrix comprising a set of sensing waveforms, _{Φi} ∈ Rⁿ, to form a compressed measurement signal, and
store the compressed measurement signal in the storage device while the component part is undergoing the additive manufacturing.
